(19) United States
(12) Patent Application Publication
(10) Pub. No.: US 2004/0001399 A1
(43) Pub. Date: Jan. 1, 2004

(54) Optical head for optical disc drive

(75) Inventor: Hiroshi Nishikawa, Saltama-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/606,245

(22) Filed: Jun. 26, 2003

(30) Foreign Application Priority Data
Jun. 26, 2002 (JP) 2002-186250

(51) Int. Cl. G11B 7/095; G11B 7/135

(52) U.S. Cl. 369/44.23; 369/112.28

(57) ABSTRACT

There is provided an optical head, which is provided with a light emitting device, a deflector, an objective lens, and an error signal detecting system. In this configuration, the deflector includes a prism having a first surface into which the light beam from the light emitting device enters, a second surface from which the light beam proceeding toward the objective lens emerges, and a third surface from which the light beam reflected by the optical disc emerges. Further, the prism satisfies a condition: θ₁=θ₂, where θ₁ represents an angle which the second surface forms with respect to the first surface, and θ₂ represents an angle which the third surface forms with respect to the first surface.

### BACKGROUND OF THE INVENTION

The present invention relates to an optical head for an optical disc drive for recording, reproducing and/or erasing data on an optical disc.

Conventionally, data recording/reproducing devices for recording/reproducing data on an optical disc have been known. Among such devices, a device which divides a light beam reflected by the optical disc into a pair of beams, and generates a servo signal in accordance with outputs of a pair of light receiving elements which receives the pair of beams, respectively, is known. An example of such a device is disclosed in Japanese Provisional Publication No. HEI 7-326084.

In the publication, an optical head is constructed as follows. The optical head includes a light source unit, a prism unit, an objective lens and a signal detecting system. A laser beam emitted from a laser diode in the light source unit passes through the prism unit and is converged by the objective lens onto the optical disc.

The laser beam reflected from the optical disc passes through the objective lens, enters the prism unit, and is then reflected by a half mirror provided in the prism unit toward the signal detecting system. In the signal detecting system, the reflected laser beam from the optical disc is divided into three beams using a Wollaston prism. One of the beams is used for generating a servo signal, and the other two beams are used as beams for generating a data signal.

Specifically, using a hologram plate, the beam for generating the servo signal is divided into a pair of beams in a direction perpendicular to a direction where the Wollaston prism divides the beam. The hologram plate causes the divided beams to defocus, with respect to a predetermined focal plane, in positive and negative directions, respectively. The beams for generating the servo signal that emerge from the hologram plate are incident on a pair of photo sensors. In accordance with the outputs of the servo sensors, the servo signal is obtained.

In the above-described optical head, each of the beams for generating the data signal is also divided into a pair of beams by the hologram plate in the direction perpendicular to the direction where the Wollaston prism divides the beam. The divided beams impinge onto two pairs of photo sensors, which are located next to the sensors for generating the servo signal. Then, based on the output of the sensors for obtaining the data, data signal (which will be occasionally referred to as an MO signal) is obtained.

FIG. 3 shows a configuration of sensors 50, 51, 50′ and 51′ and a signal processing unit 52 for a conventional optical head. FIG. 4 is an enlarged view of one of the sensors 50, 51, 50′ and 51′. The laser beam reflected from an optical disc is divided into six beams as described above in a direction corresponding to a tracking direction on the optical disc (indicated by an arrow T). In FIG. 3, the sensors for the servo signal (which will be referred to as servo sensors) are the sensors 51 and 51′ which are located between the sensors 50 and 50′ for generating the data signal (which will be referred to as data sensors).

As shown in FIGS. 3 and 4, a light receiving surface of each of servo sensors 51 and 51′ are divided into three sectional light receiving surfaces 51a-51c, and 51a′-51c′, respectively.

The signal processing unit 52 includes adders 53-59 and subtractors 60-62. The adders 53-59 and the sensors 50, 51, 50′ and 51′ are connected as shown in FIG. 3, and the subtractors 60-62 and the adder 59 are connected to the adders 53-58 as shown in FIG. 3. The subtractor 60 outputs a focus error signal (FES), the subtractor 61 outputs a tracking error signal (TES), and the adder 59 outputs a pre-format signal (i.e., an RO signal). The above mentioned method for obtaining the focus error signal is known as Spot Size method, and the above mentioned method for obtaining the tracking error signal is known as Push-Pull method.

One of the problems of the above mentioned conventional optical head is that a wavelength of the laser beam emitted by the laser diode changes due to variations of temperature. For example, the variations of temperature occur due to a difference of an optical power of the laser diode between a recording operation and a reproducing operation.

When the change of the wavelength of the laser beam of the laser diode occurs, an emergence angle of the laser beam with respect to the prism unit may change even if an incident angle of the laser beam with respect to the prism unit is kept constant.

If such a phenomenon occurs, the signal detecting system of the conventional optical head may fail to detect properly an error condition because a position of the beam on the corresponding servo sensor shifts from a predetermined position.

Japanese Provisional Publication No. P2000-276745 describes an optical head having a configuration to avoid an influence caused by variations of wavelength of the laser beam. In this publication, a compensation circuit is used to remove an error on a focus error signal caused by variations of wavelength of the laser beam.

However, to use the compensation circuit makes the optical head complicated. Further, a manufacturing cost of the optical head is increased.

Accordingly, an optical head, which is capable of avoiding the influence caused by variations of wavelength of the laser beam without employing additional circuits such as the above compensation circuit, is required.

### SUMMARY OF THE INVENTION

The present invention is advantageous in that it provides an optical head which is capable of avoiding the influence caused by variations of wavelength of the laser beam.

According to an aspect of the present invention, there is provided an optical head, which is provided with a light emitting device that emits a light beam, a deflector that deflects the light beam emitted by the light emitting device, an objective lens that converges the light beam emerged from the deflector onto an optical disc, and an error signal detecting system that generates a servo signal for servo control based on the light beam reflected by the optical disc.

In this configuration, the deflector includes a prism having a first surface into which the light beam from the light emitting device enters, a second surface from which the light beam proceeding toward the objective lens emerges, and a third surface from which the light beam reflected by the optical disc emerges, the light beam emerged from the third surface proceeding toward the error signal detecting system. Further, the prism satisfies a condition:

θ₁=−θ₂

where θ₁ represents an angle which the second surface forms with respect to the first surface, and θ₂ represents an angle which the third surface forms with respect to the first surface, polarity of each of the angles θ₁ and θ₂ being defined depending on whether the each of the angles θ₁ and θ₂ has counterclockwise direction or has clockwise direction.

With this configuration, it is possible to keep the emergence angle β₁ (an angle of the beam proceeding toward the error signal detecting system with respect to the third surface) constant even if variations of wavelength of the beam occur.

Optionally, the error signal detecting system may include a beam splitting system which divides the light beam reflected by the optical disc into a plurality of beams including a pair of beams for generating the servo signal and causes the pair of beams to defocus, with respect to a predetermined focal plane, in positive and negative directions, respectively.

Still optionally, the error signal detecting system may include a pair of sensors for the servo signal, the pair of beams divided by the beam splitting system impinging on the pair of sensors, respectively, and a signal processing unit that generates the servo signal based on outputs of the pair of sensors.

Still optionally, the servo signal generated by the pair of sensors may include a focus error signal and a tracking error signal.

In a particular case, the error signal detecting system may generate the servo signal in accordance with Spot Size method and Push-Pull method.

Optionally, the plurality of beams divided by the beam splitting system may include a beam for a data signal.

Still optionally, the first surface may be formed as a beam splitting surface.

In a particular case, the first surface may be formed as a half mirror surface.

According to another aspect of the present invention, there is provided an optical head, which is provided with a light emitting device that emits a light beam, a deflector that deflects the light beam emitted by the light emitting device, an objective lens that converges the light beam emerged from the deflector onto an optical disc, and an error signal detecting system that generates a servo signal for servo control based on the light beam reflected by the optical disc.

In this configuration, the deflector includes a prism having a first surface into which the light beam from the light emitting device enters, a second surface from which the light beam proceeding toward the objective lens emerges, and a third surface from which the light beam reflected from the optical disc emerges, the light beam emerged from the third surface proceeding toward the error signal detecting system. Further, the prism satisfies a condition:

−π/1080 radian≦α₁+β₁≦π/1080 radian

where α₁ represents an emergence angle which the light beam emerging from the second surface and proceeding toward said objective lens forms with respect to a normal to the second surface, β₁ represents an emergence angle which the light beam emerging from the third surface and proceeding toward said error signal detecting system forms with respect to a normal to the third surface, polarity of each of the angles α₁ and β₁ being defined depending on whether the each of the angles α₁ and β₁ has counterclockwise direction or has clockwise direction.

With this configuration, the influence of change of the angle β₁ caused by variations of wavelength of the beam on the operation of the signal detecting system is negligible.

Still optionally, the error signal detecting system may include a beam splitting system which divides the light beam reflected by the optical disc into a plurality of beams including a pair of beams for generating the servo signal and causes the pair of beams to defocus, with respect to a predetermined focal plane, in positive and negative directions, respectively.

Still optionally, the error signal detecting system may include a pair of sensors for the servo signal, the pair of beams divided by the beam splitting system impinging on the pair of sensors, respectively, and a signal processing unit that generates the servo signal based on outputs of the pair of sensors.

Still optionally, the servo signal generated by the pair of sensors may include a focus error signal and a tracking error signal.

In a particular case, the error signal detecting system may generate the servo signal in accordance with Spot Size method and Push-Pull method.

Optionally, the plurality of beams divided by the beam splitting system may include a beam for a data signal.

Still optionally, the first surface may be formed as a beam splitting surface.

In a particular case, the first surface may be formed as a half mirror surface.

### BRIEF DESCRIPTION OF THE ACCOMPANYING DRAWINGS

FIG. 1 shows a block diagram of a optical head according to a embodiment of the invention;

FIG. 2 shows a configuration of a prism according to the embodiment of the invention;

FIG. 3 shows sensors and a signal processing unit according to a conventional optical head; and

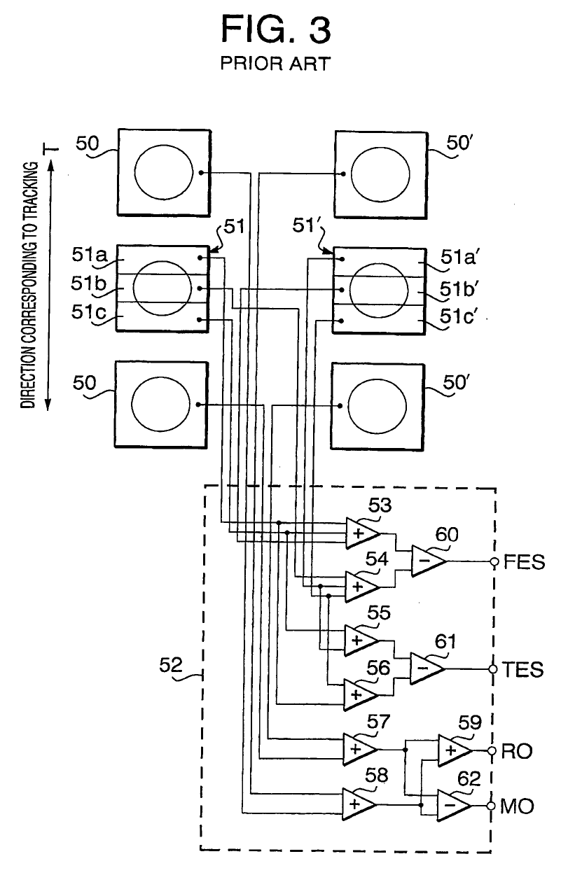

FIG. 4 is a plan view of a sensor for a servo signal showing a dividing direction on the sensor.

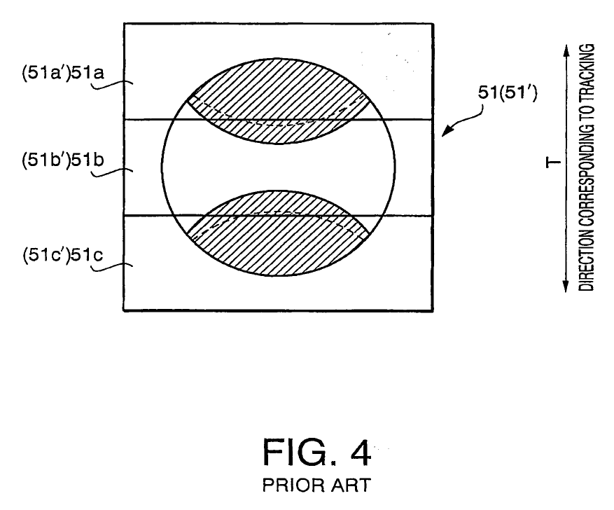

### DETAILED DESCRIPTION OF THE EMBODIMENTS

Hereinafter, an embodiment according to the invention is described with reference to the accompanying drawings.

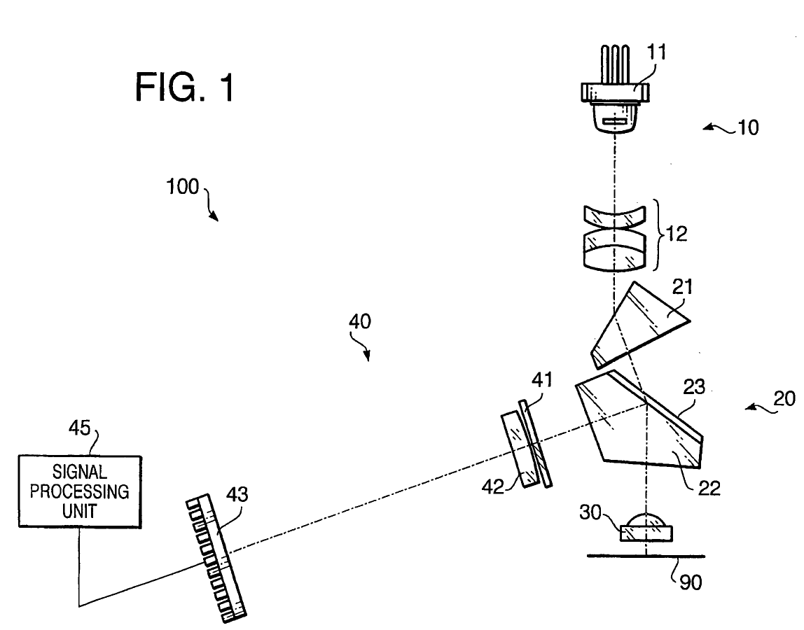

FIG. 1 shows an optical head 100 according to an embodiment of the invention. As shown in FIG. 1, the optical head includes a light source unit 10, a prism unit 20, an objective lens 30, and a signal detecting system 40.

The light source unit 10 includes a laser diode 11 which emits a divergent laser beam whose sectional shape is elliptical, and a collimating lens group 12 which collimates the divergent laser beam from the laser diode 11. The laser beam collimated by the collimating lens group 12 proceeds toward the prism unit 20.

The prism unit 20 includes an anamorphic prism 21 and a prism 22 having a half mirror surface 23. As shown in FIG. 1, the half mirror surface 23 is formed on the light source unit side surface of the prism 22. The laser beam having the elliptical shape from the collimating lens group 12 is made substantially circular by the anamorphic prism 21 and the prism 22. Then, the laser beam passed through the prism 22 is directed to the objective lens 30.

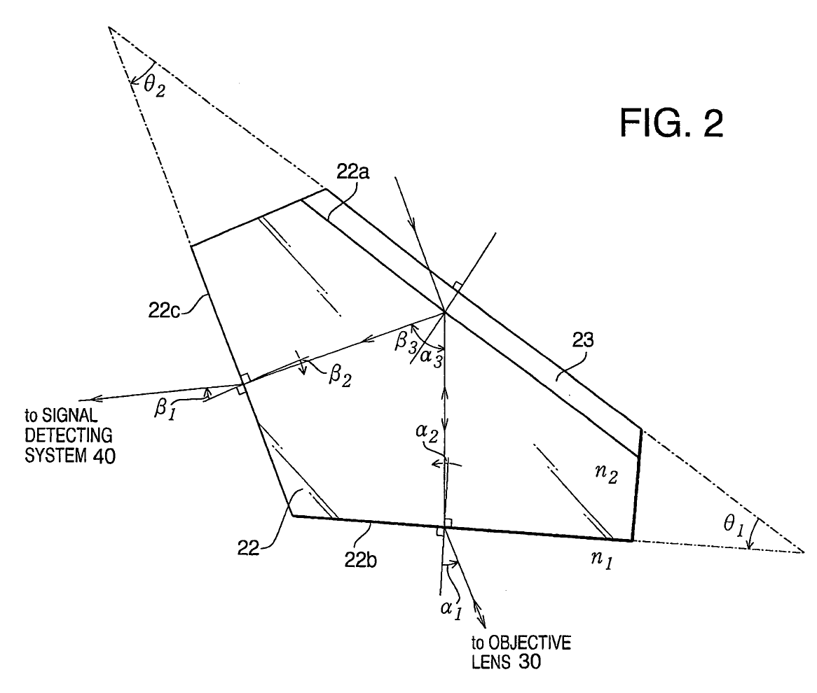

The laser beam emerged from the prism 22 is converged by the objective lens 30 onto a recording surface of an optical disc 90 which is rotated by a motor (not shown). As described below, by the function of the anamorphic prism 21 and the prism 22, the beam is properly incident on the recording surface of the optical disc 90, even if variations of wavelength of the laser beam occur. That is, an emergence angle of the beam proceeding toward the objective lens 30 with respect to a surface 22b (see FIG. 2) is kept constant, even if variations of wavelength of the laser beam occur.

The optical head 100 includes an actuator (not shown) which moves the objective lens 30 in a tracking direction (i.e., a radial direction of the optical disc 90) and in a focusing direction (i.e., a direction along an optical axis of the objective lens 30).

The laser beam reflected from the optical disc 90 passes through the objective lens 30 and enters the prism 22. Then, the laser beam is reflected by the half mirror surface 23 toward the signal detecting system 40.

The signal detecting system 40 is configured to generate a data signal and a servo signal by using known methods including the Spot Size method and the Push-Pull method described in the above publication HEI 7-326084.

More specifically, the signal detecting system 40 includes a hologram prism 41, a condenser lens 42, a combination sensor 43 and a signal processing unit 45. The hologram prism 41 is a double refracting crystal. The light beam reflected from the half mirror surface 23 is divided by the hologram prism 41 into beams for the data signal and beams for the servo signal which proceed in a common plane toward the condenser lens 42 and in directions different from each other. Each of the beam for the data signal and the beam for the servo signal is converged by the condenser lens 42 onto the combination sensor 43.

The combination sensor 43 has servo sensors for the servo signal and data sensors for the data signal. The beams deflected by the hologram prism 41 are converged by the condenser lens 42 onto the respective sensors of the combination sensor 43.

Signals output by the data sensors for the data signal are processed by the processing unit 45 to generate the data signal such as an MO signal and an RO signal described in the above-mentioned publication HEI 7-326084. Signals output by the servo sensor for the servo signal are processed by the signal processing unit 45 to generate the servo signal such as the FES and the TES.

As described above, the focusing error is detected according to the Spot Size method. That is, when the beam spot is properly focused on the optical disc 90, beam spots formed on the respective sensors of the combination sensor 43 have substantially the same size. On the contrary, when the beam spot is not properly focused on the optical disc 90, spot sizes of the beam spots on the respective sensors of the combination sensor 43 become different from each other. The difference of size between the beam spots on the respective sensors is detected by the combination sensor 43 and the signal processing unit 45, and therefore the focusing error is detected.

Next, the prism 22 will be described in detail with reference to FIG. 2 which shows a configuration of the prism 22. The prism 22 has a surface 22a corresponding to the half mirror surface 23, the surface 22b from which the laser beam proceeding toward the objective lens 30 exits, and a surface 22c from which the laser beam proceeding toward the signal detecting system 40 exits.

In FIG. 2, α₁ corresponds to an emergence angle of the laser beam proceeding to the objective lens 30 with respect to the surface 22b (α₁ also corresponds to an incident angle of the laser beam reflected from the optical disc 90 with respect to the surface 22b), α₂ corresponds to an incident angle of the laser beam proceeding to the objective lens 30 with respect to the surface 22b (α₂ also corresponds to an emergence angle of the laser beam reflected from the optical disc 90 with respect to the surface 22b). α₃ and β₃ respectively correspond to an incident angle and a reflection angle of the laser beam proceeding toward the signal detecting system 40 with respect to the surface 22a.

β₁ is an emergence angle of the laser beam proceeding to the signal detecting system 40 with respect to the surface 22c, and β₂ is an incident angle of the laser beam proceeding to the signal detecting system 40 with respect to the surface 22c.

θ₁ represents an angle which an extension of the surface 22b forms with respect to an extension of the surface 22a, and θ₂ represents an angle which an extension of formed the surface 22c forms with respect to an extension of the surface 22a.

All of the above angles are defined by radians. In this embodiment, each of incident angles, reflection angles and angles of emergence having a counterclockwise direction with respect to a corresponding normal is assigned a positive value. Also, each of incident angles, reflection angles and angles of emergence having a clockwise direction with respect to a corresponding normal is assigned a negative value. The angle θ₁ having a counterclockwise direction with respect a common line (the extension of the surface 22a) has a positive value. The angle θ₂ having a clockwise direction with respect the common line (the extension of the surface 22a) has a negative value. In FIG. 2, each angle (α₁, α₂, α₃, θ₁) has the counterclockwise direction and has a positive value, and each angle (β₁, β₂, β₃, θ₂) has the clockwise direction and has a negative value.

n1 represents a refractive index in air, and n2 represents a refractive index in the prism 22.

Further, the prism unit 22 is configured to satisfy a condition θ₁=−θ₂.

As can be seen from FIG. 2, the following equations (1)-(5) are derived:

n₁ sin α₁=n₂ sin α₂ (1)

α₃=α₂+θ₁ (2)

α₃=−β₃ (3)

β₂=β₃−θ₂ (4)

n₂ sin β₂=n₁ sin β₁ (5)

It should be appreciated that a relationship α₁=β₁ is derived from the equations (1)-(5) if the prism 22 satisfies the condition θ₁=−η₂. That is, the relationship α₁=β₁ is satisfied even if variations of refractive indices n1 and n2 occur due to variations of wavelength of the laser beam.

Therefore, it is possible to keep the emergence angle β₁ constant even if the variations of wavelength of the laser beam occur, as long as the incident angle α₁ is kept constant when the variations of wavelength of the laser beam occur. It is possible to configure the optical head 100 to keep the incident angle α₁ of the laser beam reflected from the optical disc 90 constant even if the variations of wavelength of the laser beam occur.

For example, it is possible to design the anamorphic prism 21 and the prism 22 so that the emergence angle α₁ of the beam proceeding toward the objective lens 30 with respect to the surface 22b is kept constant even if the variations of wavelength of the laser beam occur. With this structure, the incident angle of the laser beam reflected by the optical disc with respect to the surface 22b is also kept constant even if the variations of wavelength of the laser beam occur.

As described above, it is possible to keep the incident angle α₁ constant when the variations of wavelength of the laser beam occur. According to the prism 22, if the angle α₁ is kept constant, then the angle β₁ is also kept constant. Since the emergence angle β₁ is kept constant even if the variations of wavelength of the laser beam occur, the signal detecting system 40 properly detects the error condition, such as the focusing error and the tracking error, even if the variations of wavelength of the laser beam occur.

Although the embodiment has been described with respect to the optical head 100 having the configuration shown in FIG. 1, it is appreciated that the prism 22 can also be employed in various types of optical heads.

While the operation of the signal detecting system 40 is described with respect to, for example, the Push-Pull method and the Spot Size method, the invention is not limited to the use of such methods, and other methods may be used in the signal detecting system 40 without departing from the scope and/or spirit of the invention.

It should be noted that if a condition −π/1080≦α₁+β₁≦π/1080 is satisfied, the signal detecting system 40 can properly detects the error condition because the influence of change of the angle β₁ on the operation of the signal detecting system 40 is negligible. In this case, the above-mentioned condition θ₁=−θ₂ is not necessarily required.

The present disclosure relates to the subject matter contained in Japanese Patent Application No. P2002-186250, filed on Jun. 26, 2002, which is expressly incorporated herein by reference in its entirety.

What is claimed is:

1. An optical head, comprising:
a light emitting device that emits a light beam;
a deflector that deflects the light beam emitted by the light emitting device;
an objective lens that converges the light beam emerged from the deflector onto an optical disc; and
an error signal detecting system that generates a servo signal for servo control based on the light beam reflected by the optical disc,
wherein said deflector includes a prism having a first surface into which the light beam from said light emitting device enters, a second surface from which the light beam proceeding toward said objective lens emerges, and a third surface from which the light beam reflected by the optical disc emerges, the light beam emerged from the third surface proceeding toward said error signal detecting system,
wherein said prism satisfies a condition:
θ₁=−θ₂
where θ₁ represents an angle which the second surface forms with respect to the first surface, and θ₂ represents an angle which the third surface forms with respect to the first surface, polarity of each of the angles θ₁ and θ₂ being defined depending on whether the each of the angles θ₁ and θ₂ has counterclockwise direction or has clockwise direction.

2. The optical head according to claim 1, wherein said error signal detecting system includes a beam splitting system which divides the light beam reflected by the optical disc into a plurality of beams including a pair of beams for generating the servo signal and causes the pair of beams to defocus, with respect to a predetermined focal plane, in positive and negative directions, respectively.

3. The optical head according to claim 2,
wherein said error signal detecting system further includes:
a pair of sensors for the servo signal, the pair of beams divided by the beam splitting system impinging on the pair of sensors, respectively; and
a signal processing unit that generates the servo signal based on outputs of the pair of sensors.

4. The optical head according to claim 3, wherein the servo signal generated by the pair of sensors includes a focus error signal and a tracking error signal.

5. The optical head according to claim 3, said error signal detecting system generates the servo signal in accordance with Spot Size method and Push-Pull method.

6. The optical head according to claim 2, wherein the plurality of beams divided by the beam splitting system includes a beam for a data signal.

7. The optical head according to claim 1, wherein the first surface is formed as a beam splitting surface.

8. The optical head according to claim 1, wherein the first surface is formed as a half mirror surface.

9. An optical head, comprising:
a light emitting device that emits a light beam;
a deflector that deflects the light beam emitted by the light emitting device;
an objective lens that converges the light beam emerged from the deflector onto an optical disc; and
an error signal detecting system that generates a servo signal for servo control based on the light beam reflected by the optical disc,
wherein said deflector includes a prism having a first surface into which the light beam from said light emitting device enters, a second surface from which the light beam proceeding toward said objective lens emerges, and a third surface from which the light beam reflected from the optical disc emerges, the light beam emerged from the third surface proceeding toward said error signal detecting system,
wherein said prism satisfies a condition:
−π/1080 radian≦α₁+β₁≦π/1080 radian
where α₁ represents an emergence angle which the light beam emerging from the second surface and proceeding toward said objective lens forms with respect to a normal to the second surface, β₁ represents an emergence angle which the light beam emerging from the third surface and proceeding toward said error signal detecting system forms with respect to a normal to the third surface, polarity of each of the angles α₁ and β₁ being defined depending on whether the each of the angles α₁ and β₁ has counterclockwise direction or has clockwise direction.

10. The optical head according to claim 9, wherein said error signal detecting system includes a beam splitting system which divides the light beam reflected by the optical disc into a plurality of beams including a pair of beams for generating the servo signal and causes the pair of beams to defocus, with respect to a predetermined focal plane, in positive and negative directions, respectively.

11. The optical head according to claim 10,
wherein said error signal detecting system further includes:
a pair of sensors for the servo signal, the pair of beams divided by the beam splitting system impinging on the pair of sensors, respectively; and
a signal processing unit that generates the servo signal based on outputs of the pair of sensors.

12. The optical head according to claim 11, wherein the servo signal generated by the pair of sensors includes a focus error signal and a tracking error signal.

13. The optical head according to claim 11, said error signal detecting system generates the servo signal in accordance with Spot Size method and Push-Pull method.

14. The optical head according to claim 10, wherein the plurality of beams divided by the beam splitting system includes a beam for a data signal.

15. The optical head according to claim 9, wherein the first surface is formed as a beam splitting surface.

16. The optical head according to claim 9, wherein the first surface is formed as a half mirror surface.
